(19) United States
(12) Patent Application Publication
(10) Pub. No.: US 2026/0018106 A1
(43) Pub. Date: Jan. 15, 2026

(54) DRIVER CIRCUIT AND DISPLAY DEVICE

(71) Applicant: Sharp Display Technology Corporation, Kameyama City (JP)

(72) Inventors: Seiya KAWAMORITA, Kameyama City (JP); Yasuaki IWASE, Kameyama City (JP); Shinji MATSUBARA, Kameyama City (JP)

(21) Appl. No.: 19/262,525

(22) Filed: Jul. 8, 2025

(30) Foreign Application Priority Data
Jul. 9, 2024 (JP) 2024-110455

(51) Int. Cl. G09G 3/20; G09G 3/36

(52) U.S. Cl. CPC G09G 3/2096; G09G 3/3674; G09G 2310/0286; G09G 2330/023; G09G 2340/0435

(57) ABSTRACT

A driver circuit includes unit circuits. The driver circuit drives a plurality of signal lines. One of the unit circuits in an nth stage includes an input terminal that receives a clock signal, a drive terminal that outputs a drive signal to one of the plurality of signal lines, a first node, a first transistor having a gate terminal connected to the first node, a set transistor having a gate terminal that receives a set signal from a different stage, and a control terminal. The input terminal is connected to the drive terminal with the first transistor interposed between the input terminal and the drive terminal. The control terminal is connected to the first node with the set transistor interposed between the control terminal and the first node. The control terminal receives a first enable signal that specifies whether to enable or disable outputting the drive signal.

### BACKGROUND

### 1. Field

The present disclosure relates to a driver circuit.

### 2. Description of the Related Art

Japanese Unexamined Patent Application Publication No. 2011-209714 discloses a partial output method for partially outputting a scan signal in a driver circuit of a display device.

In the use of the method in the related art, a waveform of a clock signal is to be set, and thus there is an issue that control for partial output is not easy.

### SUMMARY

According to an aspect of the disclosure, there is provided a driver circuit including: unit circuits in a plurality of stages, the driver circuit driving a plurality of signal lines, one of the unit circuits in an nth stage including an input terminal that receives a clock signal, a drive terminal that outputs a drive signal to one of the plurality of signal lines, a first node, a first transistor having a gate terminal connected to the first node, a set transistor having a gate terminal that receives a set signal from a different stage, and a control terminal, the input terminal being connected to the drive terminal with the first transistor interposed between the input terminal and the drive terminal, the control terminal being connected to the first node with the set transistor interposed between the control terminal and the first node, the control terminal receiving a first enable signal that specifies whether to enable or disable outputting the drive signal.

### BRIEF DESCRIPTION OF THE DRAWINGS

FIG. 1 is a schematic diagram illustrating a configuration of a driver circuit according to an embodiment;

FIG. 2 is a timing chart illustrating the operations of the driver circuit according to this embodiment;

FIG. 3A is a circuit diagram illustrating a configuration of a unit circuit of the driver circuit according to this embodiment;

FIG. 3B is a circuit diagram illustrating a configuration of a unit circuit of the driver circuit according to this embodiment;

FIG. 4 is a schematic diagram illustrating a configuration of the driver circuit according to this embodiment;

FIG. 5 is a timing chart illustrating the operations of the driver circuit according to this embodiment;

FIG. 6 is a block diagram illustrating the configuration of the display device according to this embodiment;

FIG. 7 is a schematic diagram illustrating a configuration of the driver circuit according to this embodiment;

FIG. 8 is a timing chart illustrating the operations of the driver circuit according to this embodiment;

FIG. 9 is a timing chart illustrating the operations of the driver circuit according to this embodiment;

FIG. 10 is a schematic diagram illustrating a configuration of the driver circuit according to this embodiment;

FIG. 11 is a timing chart illustrating the operations of the driver circuit according to this embodiment;

FIG. 12 is a circuit diagram illustrating an example configuration of part of FIG. 10 (two adjacent unit circuits);

FIG. 13 is a schematic diagram illustrating a configuration of the driver circuit according to this embodiment;

FIG. 14A is a circuit diagram illustrating an example configuration of a unit circuit;

FIG. 14B is a circuit diagram illustrating an example configuration of a unit circuit; and

FIG. 15 is a timing chart illustrating the operations of the driver circuit according to this embodiment.

### DESCRIPTION OF THE EMBODIMENTS

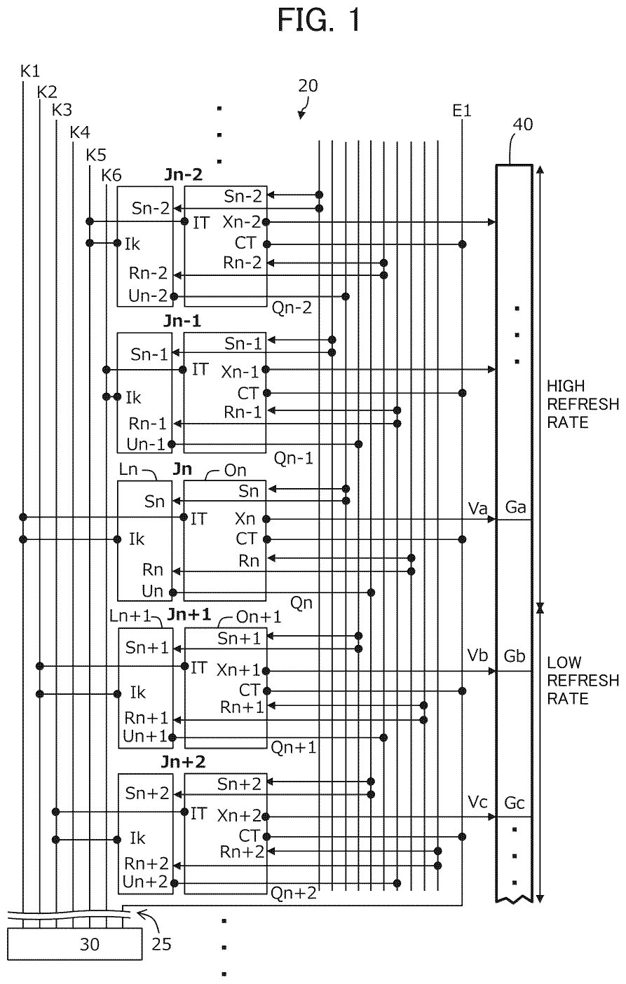

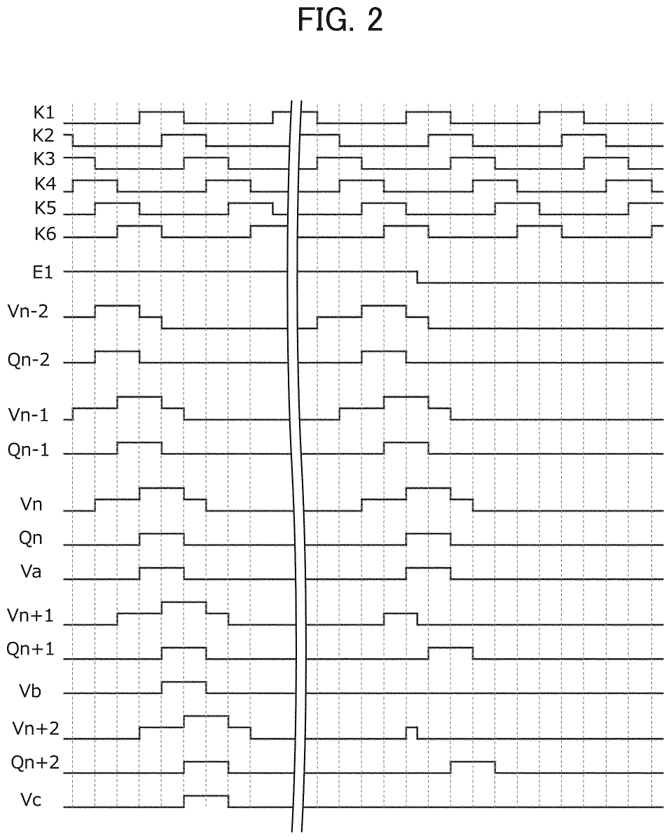

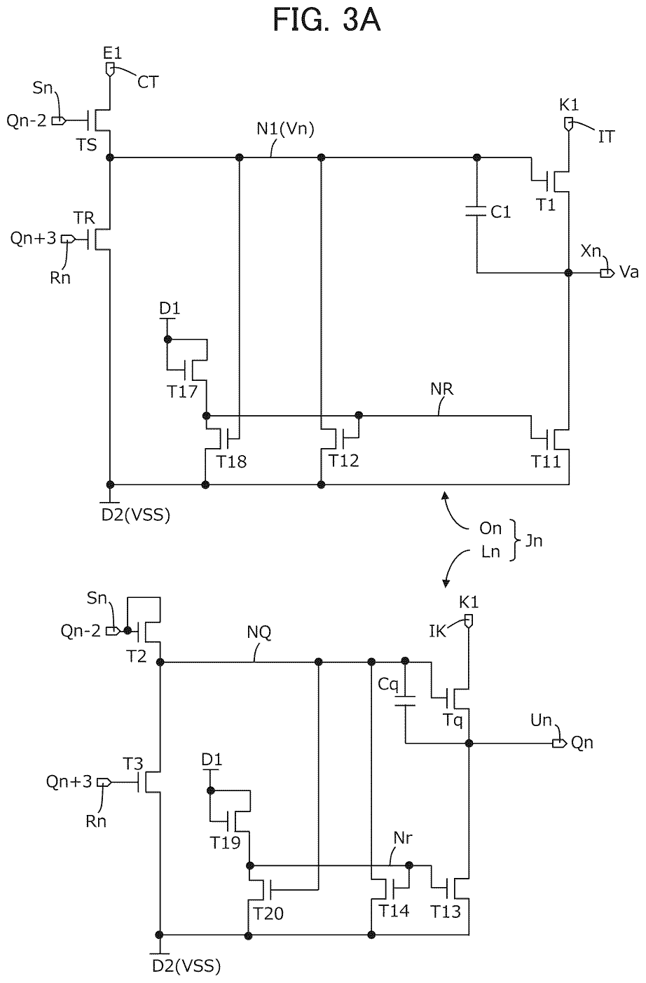

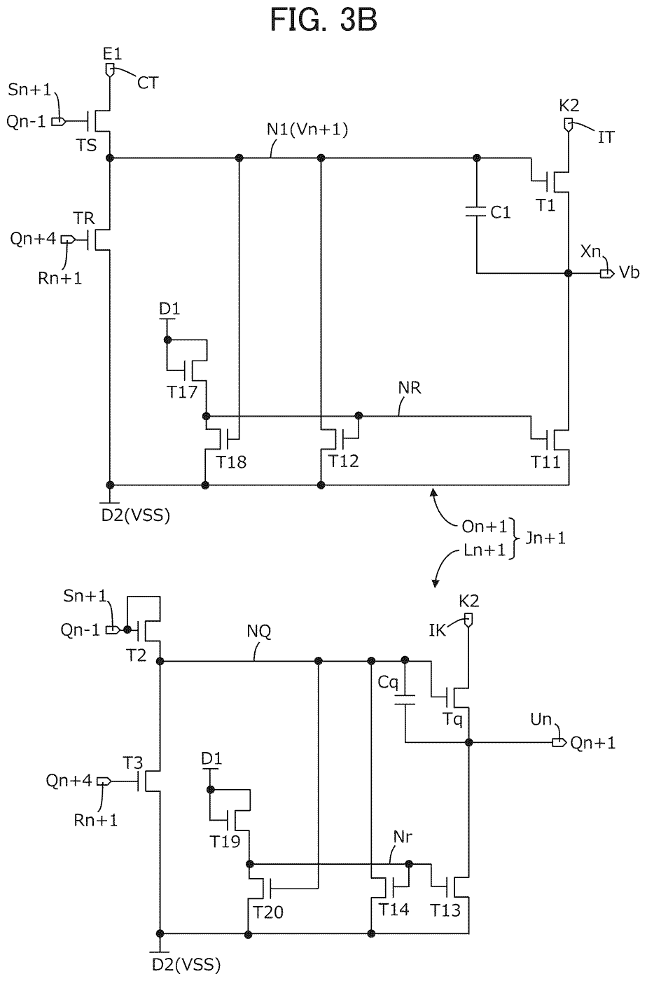

FIG. 1 is a schematic diagram illustrating a configuration of a driver circuit according to an embodiment. FIG. 2 is a timing chart illustrating the operations of the driver circuit according to this embodiment. FIGS. 3A and 3B are each a circuit diagram illustrating a configuration of a unit circuit of the driver circuit according to this embodiment. As illustrated in FIG. 1 to FIG. 3B, a driver circuit 20 includes unit circuits in a plurality of stages (such as Jn, Jn−1, and Jn+1). The driver circuit 20 is a driver circuit that drives a plurality of signal lines (such as Ga to Gc), and one of the unit circuits Jn in the nth stage includes an input terminal IT that receives a clock signal K1, a drive terminal Xn that outputs a drive signal Va to one of the plurality of signal lines, a first node N1, a first transistor T1 with a gate terminal connected to the first node N1, a set transistor TS with a gate terminal to receive a set signal (for example, Qn−2) from a different stage, and a control terminal CT.

The input terminal IT is connected to the drive terminal Xn with the first transistor T1 interposed therebetween. The control terminal CT is connected to the first node N1 with the set transistor TS interposed therebetween. The control terminal CT receives a first enable signal E1 that specifies whether to enable or disable outputting the drive signal Va.

As described above, whether to enable or disable outputting the drive signal Va is specified by using the first enable signal E1 input via the set transistor TS, and thereby control for the partial output is made easy.

Hereinafter, n is a natural number. For example, a voltage at the first node N1 of the unit circuit Jn is Vn, and a voltage at the first node N1 of the unit circuit Jn+1 is Vn+1. In addition, i is a natural number, and “n+i” or “n−i” may denote matter related to a unit circuit in the (n+i)th stage or a unit circuit in the (n−i)th stage.

As illustrated in FIGS. 3A and 3B, the unit circuit Jn in the nth stage may include a clock terminal IK that receives the clock signal K1, a set terminal Un that outputs a set signal Qn to a unit circuit in a different stage, a set node NQ, a set transistor Tq having a gate terminal connected to the set node NQ, a second transistor T2 having a gate terminal that receives a set signal (for example, Qn−2).

The clock terminal IK may be connected to the set terminal Un with the set transistor Tq interposed therebetween. The set node NQ may be connected to one of two conductive terminals (a source terminal and a drain terminal) of the second transistor T2, and the gate terminal of the second transistor T2 may be connected to the other one of the two conductive terminals. The second transistor T2 may be diode-connected.

The second transistor T2 is diode-connected in FIG. 3A and the like; however, the connection is not limited thereto. One of the conductive terminals of the second transistor T2 may be connected to the set node NQ, and the other (a drain terminal if the second transistor T2 is an n-channel transistor) may be connected to a higher-potential power line.

The unit circuit Jn in the nth stage may include a first capacitor C1 and a set capacitor Cq. The first node N1 is connected to the drive terminal Xn with the first capacitor C1 interposed therebetween. The set node NQ may be connected to the set terminal Un with the set capacitor Cq interposed therebetween.

The unit circuit Jn in the nth stage may include an output circuit On and a register circuit In, the output circuit On including the input terminal IT, the drive terminal Xn, the first node N1, and the control terminal CT, the register circuit In including the clock terminal IK, the set terminal Un, and the set node NQ.

Each of a unit circuit Jn−1 in the (n−1)th stage, the unit circuit Jn in the nth stage, and a unit circuit Jn+1 in the (n+1)th stage may include the output circuit On and the register circuit In, the output circuit On including the input terminal IT, the drive terminal Xn, the first node N1, and the control terminal CT, the register circuit Ln including the clock terminal IK, the set terminal Un, and the set node NQ.

As illustrated in FIG. 2, in the unit circuit Jn in the nth stage, the drive signal Va may become active (the pulse of the drive signal Va may rise) in an active period of the first enable signal E1. Suppose a case where the first enable signal E1 is active (High). In this case, in a setting period (a period in which a set signal Qn−2 is active), the first node N1 becomes active (High), and the first transistor T1 becomes on. Accordingly, the clock signal K1 is output to the drive terminal Xn. In the setting period (the period in which Qn−2 is active), the set node NQ becomes active (High), and the set transistor Tq becomes on. The clock signal K1 is also output to the set terminal Un.

As in FIG. 2, if the first enable signal E1 becomes inactive while the set signal Qn output from the unit circuit Jn is active (if the first enable signal E1 falls from High to Low in the High period of the set signal Qn), the first transistor T1 of the unit circuit Jn remains on, and a pulse is output to the drive signal Va of the unit circuit Jn. However, in the unit circuit Jn+1 and a unit circuit Jn+2, the first transistor T1 does not become on, and thus pulses are not output to respective drive signals Vb and Vc of the unit circuit Jn+1 and the unit circuit Jn+2. The output of the drive pulse is stopped.

As illustrated in FIG. 2, in the unit circuit Jn in the nth stage, the drive signal Va does not become active in the inactive period of the first enable signal E1. Suppose a case where the first enable signal E1 is inactive (Low). In this case, in the setting period (the period in which Qn−2 is active), the first node N1 is inactive (Low), and the first transistor T1 is off. Accordingly, the clock signal K1 is not output to the drive terminal Xn. Eve if the first enable signal E1 is inactive, a pulse of the clock signal K1 is output to the set terminal Un in the setting period. In other words, even if the first enable signal E1 becomes inactive (Low), a shift operation (Q signal output) continues in the driver circuit 20.

In the example illustrated in FIGS. 1 and 2, an area including the signal line (scan line) Ga has a high refresh rate, an area including the signal lines (scan lines) Gb and Gc has a low refresh rate, and the signal line Ga is located at the edge of the high refresh rate area. For example, the drive signal Va to be supplied to the signal line Ga may become active 60 times per second (refresh rate: 60 Hz), whereas the drive signals Vb and Vc to be supplied to the respective signal lines Gb and Gc may become active approximately one to ten times per second (refresh rate: 1 to 10 Hz). A moving image may be displayed in the high refresh rate area, and a still image may be displayed in the low refresh rate area. For example, the high refresh rate area may have a refresh rate of 240 Hz, and the low refresh rate area may have a refresh rate of 60 Hz.

In the active period of the first enable signal E1, activation of the first node N1 in response to the set signal (Qn−2) may cause the first transistor T1 to be on and the first capacitor C1 to be charged, and rise of the clock signal K1 may cause a voltage at the first node N1 to be increased. This causes the driving capability of the first transistor T1 to be improved, causes the potential Vn at the first node N1 to be kept active (High) (the first transistor T1 is on) until a reset period, and causes the pulse of the clock signal K1 to be output to the drive terminal Xn with high accuracy.

Activation (High) of the set signal (Qn−2) in response to the set node NQ may cause the set transistor Tq to be on and the set capacitor Cq to be charged, and rise of the clock signal K1 may cause a voltage at the set node NQ to be increased. This causes the driving capability of the set transistor Tq to be improved, causes the potential at the set node NQ to be kept active (High) (the set transistor Tq is on) until the reset period, and causes the pulse of the clock signal K1 to be output to the set terminal Un with high accuracy.

The driver circuit 20 may include a first power line D1 (for example, a higher-potential power line or a VDD line) and a second power line D2 (for example, a lower-potential power line or a VSS line). The unit circuit Jn in the nth stage may have a reset transistor TR that receives a reset signal (for example, Qn+3) from the succeeding stage side, and the first node N1 may be connected to the second power line D2 with the reset transistor TR interposed therebetween. In the reset period, the potential at the first node N1 becomes inactive (Low), and the first transistor T1 becomes off. Accordingly, the clock signal K1 is not output to the drive terminal Xn.

The unit circuit Jn in the nth stage may have a third transistor T3 that receives a reset signal (for example, Qn+3) from the succeeding stage side, and the set node NQ may be connected to the second power line D2 with the third transistor T3 interposed therebetween. In the reset period, the potential at the set node NQ becomes inactive (Low), and the set transistor Tq becomes off. Accordingly, the clock signal K1 is not output to the set terminal Un.

The unit circuit Jn in the nth stage may have a reverse node NR in a state reverse to the state of the first node N1 and a plurality of pulldown transistors T11 and T12 having the respective gate terminals connected to the reverse node NR. The drive terminal Xn and the first node N1 may each be connected to the second power line D2 with a corresponding one of the pulldown transistors T11 and T12 interposed therebetween. That is, the drive terminal Xn may be connected to the second power line D2 with the pulldown transistor T11 interposed therebetween, and the first node N1 may be connected to the second power line D2 with the pulldown transistor T12 interposed therebetween.

This causes the pulldown transistors T11 and T12 to become off in the period in which the first node N1 is active (High) but the first node N1 to become inactive (Low) (the reverse node NR becomes active (High)). The first transistor T1 thereby becomes off, and the pulldown transistors T11 and T12 become on. This causes the potential at the drive terminal Xn to be kept at the Low level regardless of the level of the clock signal K1, and the drive signal Va to be kept inactive (Low).

The unit circuit Jn in the nth stage may have a reverse node Nr in a state reverse to the state of the set node NQ and a plurality of pulldown transistors T13 and T14 having the gate terminals connected to the reverse node Nr. The set terminal Un and the set node NQ may each be connected to the second power line D2 with a corresponding one of the pulldown transistors T13 and T14 interposed therebetween. That is, the set terminal Un may be connected to the second power line D2 with the pulldown transistor T13 interposed therebetween, and the set node NQ may be connected to the second power line D2 with the pulldown transistor T14 interposed therebetween.

This causes the pulldown transistors T13 and T14 to become off in the period in which the set node NQ is active (High) but the set node NQ to be inactive (Low) (the reverse node Nr becomes active (High)). The set transistor Tq thereby becomes off, and the pulldown transistors T13 and T14 become on. This causes the potential at the set terminal Un to be kept at the Low level regardless of the level of the clock signal K1 and causes the set signal Qn to be kept inactive (Low).

In the unit circuit Jn in the nth stage, the reverse node NR may be connected to the first power line D1 (higher-potential power line) with a diode-connected transistor T17 (power transistor) interposed therebetween and also connected to the second power line D2 (lower-potential power line) with a transistor T18 (reverse transistor) interposed therebetween, and the gate terminal of the transistor T18 may be connected to the first node N1. The transistors T11, T12, T17, and T18 may configure a reverse circuit.

In the unit circuit Jn in the nth stage, the reverse node Nr may be connected to the first power line D1 (higher-potential power line) with a diode-connected transistor T19 (power transistor) interposed therebetween and also connected to the second power line D2 (lower-potential power line) with a transistor T20 (the reverse transistor) interposed therebetween, and the gate terminal of the transistor T20 may be connected to the set node NQ. The transistors T13, T14, T19, and T20 may configure the reverse circuit.

As illustrated in FIG. 1, the driver circuit 20 may include a signal generation circuit 30 that generates clock signals K1 to K6 and the first enable signal E1 and input lines 25 through which the clock signals K1 to K6 and the first enable signal E1 are transmitted.

In FIGS. 3A and 3B, the first to third transistors T1 to T3, the set transistor Tq, the set transistor TS, the reset transistor TR, the pulldown transistors T11 to T14, and the transistors T17 to T20 may be n-channel transistors but are not limited thereto. These transistors may be configured as p-channel transistors or may be configured as the n-channel transistors and the p-channel transistor.

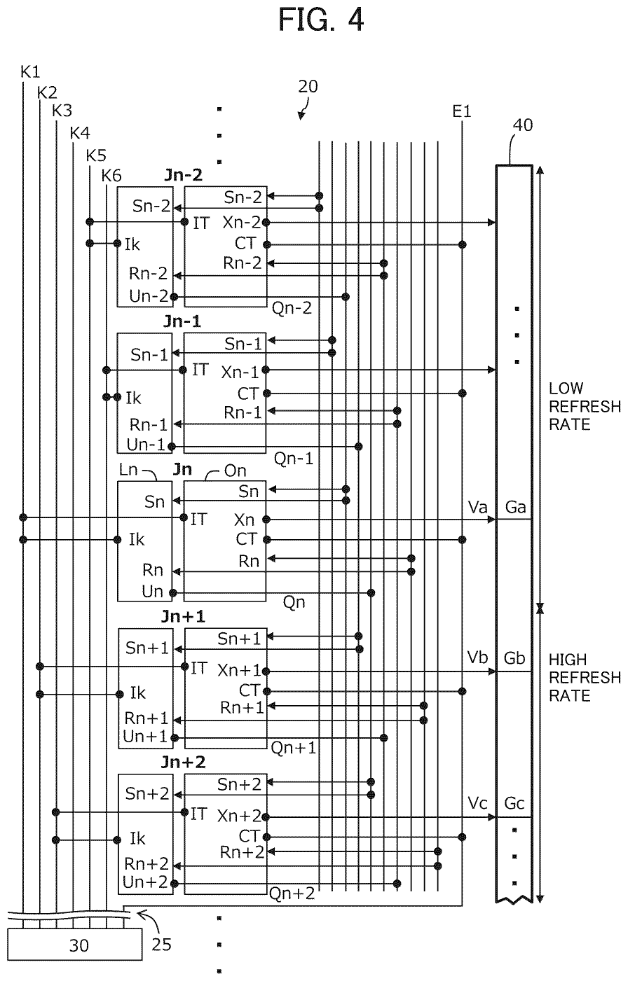

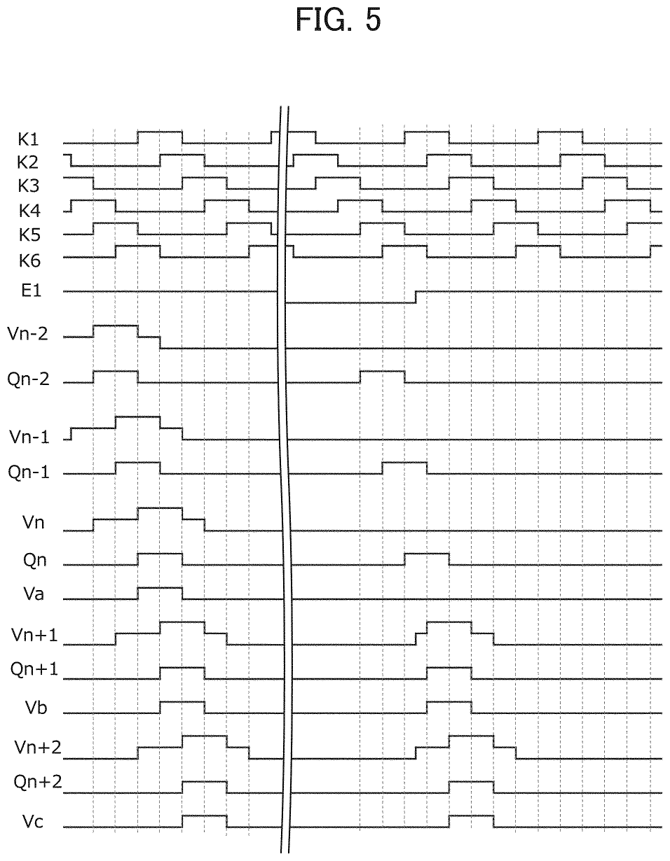

FIG. 4 is a schematic diagram illustrating a configuration of the driver circuit according to this embodiment. FIG. 5 is a timing chart illustrating the operations of the driver circuit according to this embodiment. In the example in FIGS. 4 and 5, an area including the signal line (scan line) Ga has a low refresh rate, and an area including the signal lines (scan lines) Gb and Gc has a high refresh rate. For example, the drive signal Va supplied to the signal line Ga may become active approximately one to ten times per second, whereas the drive signals Vb and Vc supplied to the signal lines Gb and Gc may each become active 60 times per second.

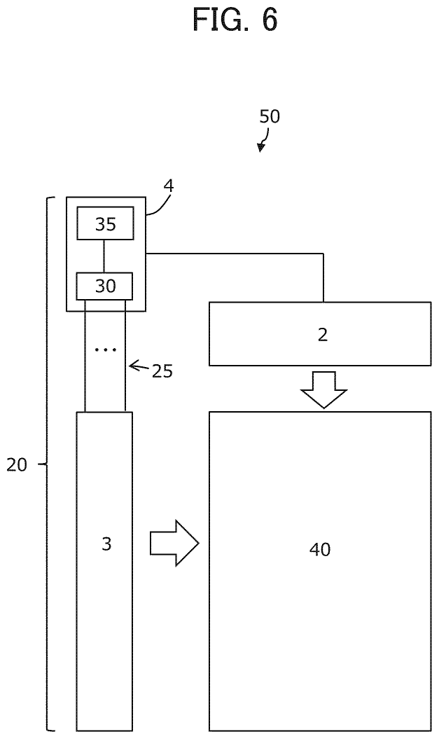

FIG. 6 is a block diagram illustrating the configuration of a display device according to this embodiment. As illustrated in FIG. 6, a display device 50 according to this embodiment may include a display unit 40, a data driver 2, a scanner driver 3, and a controller 4. A refresh rate may be set on a per-area basis in the display unit 40. The driver circuit 20 may include the scanner driver 3 (a shift register circuit), the controller 4, and the input lines 25. The controller 4 may include the signal generation circuit 30 and a processor 35. The controller 4 may be a timing controller.

In the display device 50, the display unit 40 may have a plurality of liquid crystal capacitors (including a pixel electrode, a counter electrode, and a liquid crystal layer). In the display device 50, the display unit 40 may have a plurality of light-emitting devices (for example, organic light emitting diodes or quantum dot light emitting diodes), and the driver circuit 20 may include at least one of the scanner driver or the light-emitting control driver.

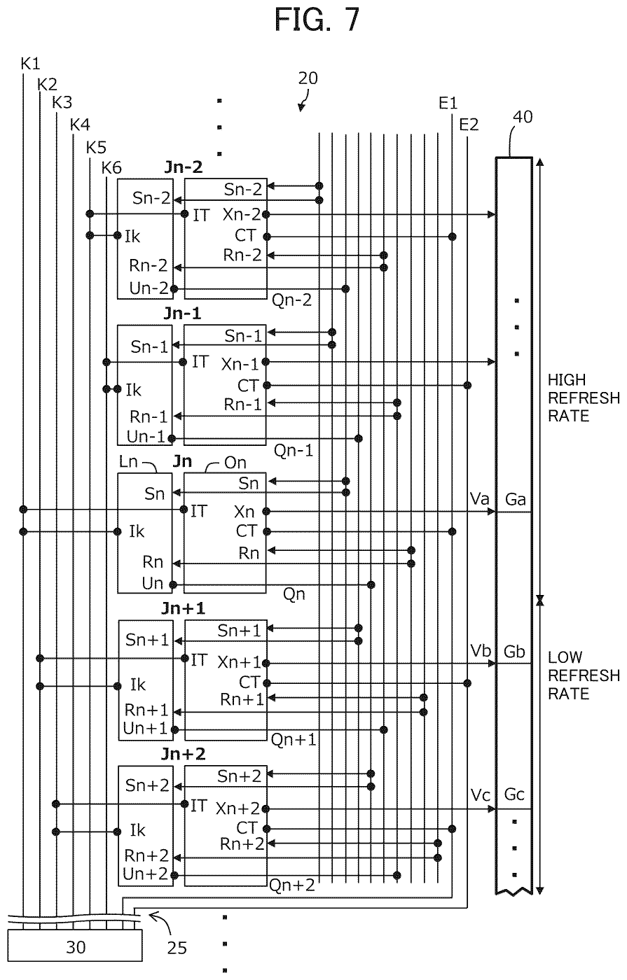

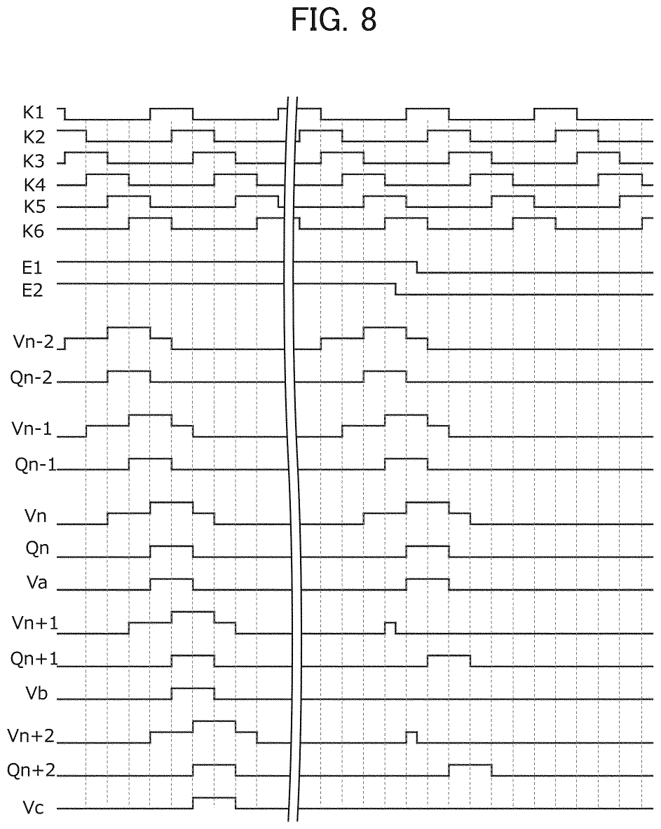

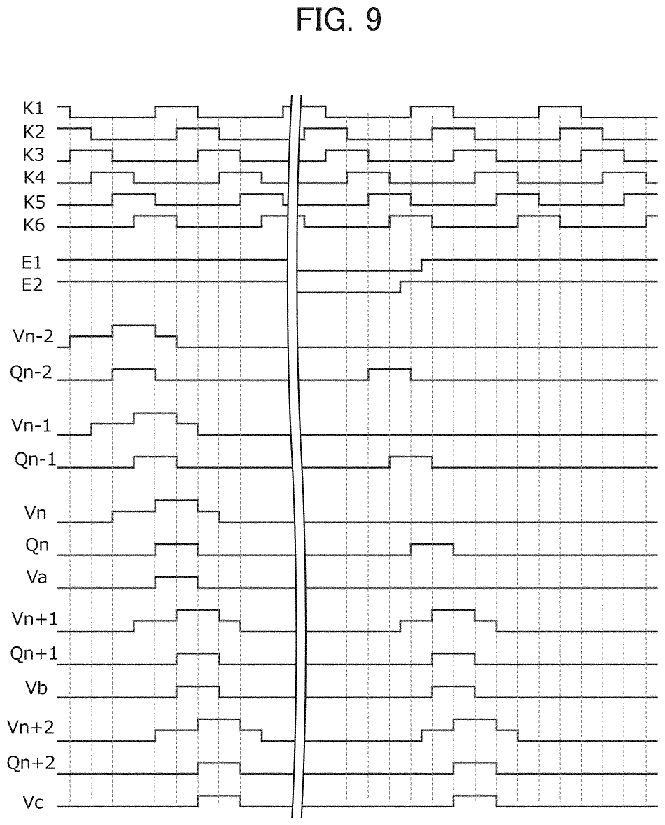

FIG. 7 is a schematic diagram illustrating a configuration of the driver circuit according to this embodiment. FIGS. 8 and 9 are each a timing chart illustrating the operations of the driver circuit according to this embodiment. As illustrated in FIGS. 7 to 9, the unit circuit Jn in the nth stage may receive the first enable signal E1, and the unit circuit Jn+1 in the (n+1)th stage may receive a second enable signal E2.

Activation timing between the first enable signal E1 and the second enable signal E2 may differ by a predetermined time. Deactivation timing between the first enable signal E1 and the second enable signal E2 may differ by a predetermined time. Each predetermined time (shift time) may be shorter than time corresponding to the pulse width of the clock signals K1 and K2, and the predetermined time may be time corresponding to half of the pulse width of the clock signals K1 and K2. The predetermined time may be time (for example, one hour=one horizontal scan period) corresponding to a phase difference between the clock signal K1 input to the unit circuit Jn in the nth stage and the clock signal K2 input to the unit circuit Jn+1 in the (n+1)th stage.

This enables the waveform of the drive signal Vb of the unit circuit Jn+1 to be ensured even if a signal delay occurs. For example, the clock signals K1 to K6 are active for two hours in six-hour cycles. In FIG. 2, the discharge delay margin (a period from the fall of the first enable signal E1 to the rise of the setting signal Qn+1) of the first node N1 of the unit circuit Jn+1 is 0.5 hours. However, in FIG. 8, the discharge delay margin (a period from the fall of the second enable signal E2 to the rise of the setting signal Qn+1) is increased to 1.5 hours. In the example in FIG. 8, an area including the signal line (scan line) Ga has a high refresh rate, an area including the signal lines (scan lines) Gb and Gc has a low refresh rate (FIG. 7), and the signal line Ga is located at the edge of the high refresh rate area.

In addition, in FIG. 5, the charge delay margin (a period from the rise of the first enable signal E1 to the rise of the setting signal Qn+1) of the first node N1 of the unit circuit Jn+1 is 0.5 hours. However, in FIG. 9, the charge delay margin (the period from the rise of the second enable signal E2 to the rise of the setting signal Qn+1) is increased to 1.5 hours. FIG. 9 illustrates a case where an area including the signal line (scan line) Ga has a low refresh rate, an area including the signal lines (scan lines) Gb and Gc has a high refresh rate, and the signal line Ga is located at the edge of the low refresh rate area.

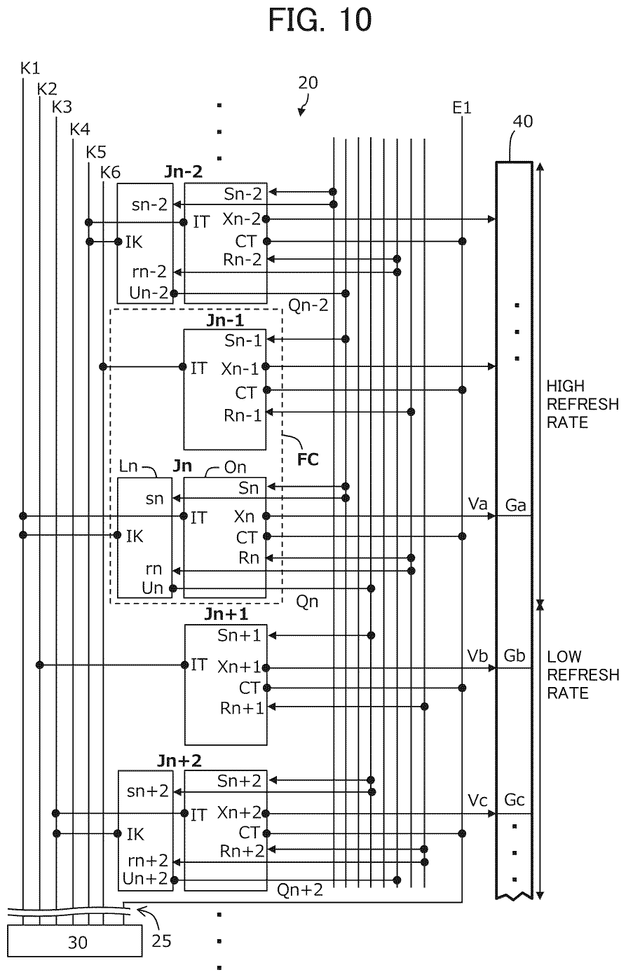

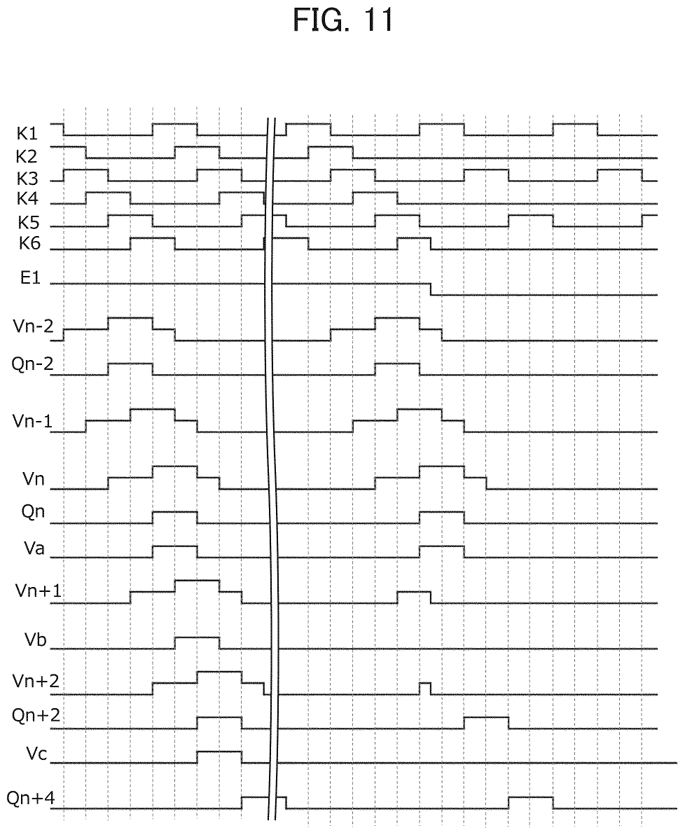

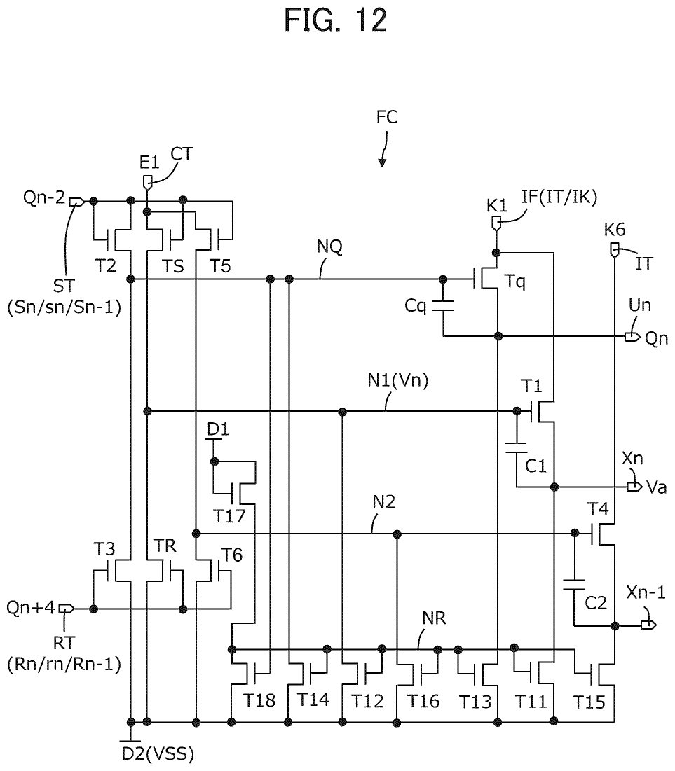

FIG. 10 is a schematic diagram illustrating a configuration of the driver circuit according to this embodiment. FIG. 11 is a timing chart illustrating the operations of the driver circuit according to this embodiment. FIG. 12 is a circuit diagram illustrating an example configuration of part of FIG. 10 (two adjacent unit circuits). As illustrated in FIGS. 10 to 12, the unit circuit Jn−1 in the (n−1)th stage and the unit circuit Jn+1 in the (n+1)th stage each include an output circuit including the input terminal IT, the drive terminal Xn, the first node N1, and the control terminal CT but may have a configuration without a register circuit. The following configuration is thus adopted. The unit circuit Jn in the nth stage includes the output circuit On and the register circuit In, but the unit circuit Jn−1 and the unit circuit Jn+1 in the stages respectively preceding and succeeding the unit circuit Jn in the nth stage include only the output circuit and does not include the register circuit.

The unit circuit Jn−1 illustrated in FIGS. 10 to 12 includes the input terminal IT that receives the clock signal K6, a drive terminal Xn−1, a set terminal Sn−1 (the gate terminal of the set transistor TS) that receives the set signal Qn−2, a reset terminal Rn−1 that receives a reset signal Qn+4, and the control terminal CT that receives the first enable signal E1.

The unit circuit Jn illustrated in FIGS. 10 to 12 includes the input terminal IT that receives the clock signal K1, the drive terminal Xn, a set terminal Sn (the gate terminal of the set transistor TS) that receives the set signal Qn−2, the reset terminal Rn−1 that receives the reset signal Qn+4, the control terminal CT that receives the first enable signal E1, the clock terminal IK that receives the clock signal K1, the output terminal Un, a set terminal sn (the gate terminal of the second transistor T2) that receives the set signal Qn−2, and a reset terminal rn (the gate terminal of the third transistor T3) that receives the reset signal Qn+4.

Herein, n is 3 or more, and the unit circuit in the first stage may include the output circuit and the register circuit. In this case, as illustrated in FIG. 11, only set signals (such as Qn and Qn+2) output from the odd-number stages (such as Jn and Jn+2) cause the shift operation in the driver circuit 20 to be continued. In the period in which the first enable signal E1 is active, the drive signals (Va, Vb, and Vc) are output from the unit circuits (for example, Jn, Jn+1, and Jn+2).

If the first enable signal E1 becomes inactive while the set signal Qn output from the unit circuit Jn is active (if the first enable signal E1 falls from High to Low in the High period of the set signal Qn) as in FIG. 11, the first transistor T1 of the unit circuit Jn remains on, and a pulse is output to the drive signal Va of the unit circuit Jn. However, in the unit circuit Jn+1 and a unit circuit Jn+2, the first transistor T1 does not become on, and thus pulses are not output to the respective drive signals Vb and Vc of the unit circuit Jn+1 and the unit circuit Jn+2. The output of the drive pulse is stopped. This enables the area including the signal lines (scan lines) Gb and Gc in the display unit 40 to be the low refresh rate area.

Further, as illustrated in FIG. 11, the clock signals K1 and K6 with the respective different phases are input to the unit circuit Jn in the nth stage and the unit circuit Jn−1 in the (n−1)th stage. However, only Q signals output from, for example, the unit circuits in the odd-number stages (such as Jn and Jn+2) cause the shift operation in the driver circuit 20 to continue, and thus the clock signal K6 input to the unit circuit Jn−1 in the (n−1)th stage (for example, a clock signal input to an even-number stage) may be kept inactive in the inactive period of the first enable signal E1 (Low period). This enables power consumption to be reduced.

The unit circuit Jn−1 in the (n−1)th stage and the unit circuit Jn in the nth stage in FIG. 10 may be combined to serve as an combined circuit FC as in FIG. 12. Since the set terminals Sn, sn, and Sn−1 in the unit circuit Jn−1 and the unit circuit Jn receive a common set signal Qn−2, these set terminals (Sn, sn, and Sn−1) may serve as a common set terminal ST in the combined circuit FC in FIG. 12.

Since the reset terminals Rn, rn, and Rn−1 in the unit circuit Jn−1 and the unit circuit Jn receive the common reset signal Qn+4, these reset terminals (Rn, rn, and Rn−1) may serve as a common reset terminal RT in the combined circuit FC in FIG. 12.

Since the control terminals CT in the unit circuit Jn−1 and the unit circuit Jn receive the common first enable signal E1, these control terminals CT may be shared in the combined circuit FC in FIG. 12.

Since the input terminal IT and the clock terminal IK receive the common clock signal K1 in the unit circuit Jn, these terminals may serve as a common terminal as a common input terminal IF in the combined circuit FC in FIG. 12.

The combined circuit FC may include a second capacitor C2, fourth to sixth transistors T4 to T6, and the eleventh to eighteenth transistors T11 to T18 in addition to the first node N1, the set node NQ, the first to third transistors T1 to T3, the set transistor Tq, and the first capacitor C1.

In FIG. 12, the input terminal IF that receives the clock signal K1 is connected to the drive terminal Xn with the first transistor T1 interposed therebetween and is also connected to the set terminal Un with the set transistor Tq interposed therebetween. The gate terminal of the first transistor T1 is connected to the first node N1, and the first node N1 is connected to the drive terminal Xn with the first capacitor C1 interposed therebetween. The input terminal IT that receives the clock signal K6 is connected to the drive terminal Xn−1 with the fourth transistor T4 interposed therebetween. The gate terminal of the fourth transistor T4 is connected to a second node N2, and the second node N2 is connected to the drive terminal Xn−1 with the second capacitor C2 interposed therebetween.

The control terminal CT that receives the first enable signal E1 is connected to the first node N1 with the set transistor TS interposed therebetween and is also connected to the second node N2 with the transistor T5 interposed therebetween. The gate terminals (for the set terminal ST) of the set transistor TS and the transistor T5 receive the set signal Qn−2. The set terminal ST is connected to the set node NQ with the transistor T2 interposed therebetween. In the transistor T2, one of the conductive terminals (for example, the drain terminal) is connected to the set terminal ST; however, the connection is not limited thereto. One of the conductive terminals may be connected to the first power line D1.

The gate terminals (for the reset terminal RT) of the reset transistor TR, the transistor T3, and the transistor T6 receive the reset signal Qn+4. The first node N1 is connected to the second power line D2 with the reset transistor TR interposed therebetween, the second node N2 is connected to the second power line D2 with the transistor T6 interposed therebetween, and the set node NQ is connected to the second power line D2 with the transistor T3 interposed therebetween.

The drive terminal Xn is connected to the second power line D2 with the pulldown transistor T11 interposed therebetween, and the first node N1 is connected to the second power line D2 with the pulldown transistor T12 interposed therebetween. The set terminal Un is connected to the second power line D2 with the pulldown transistor T13 interposed therebetween, and the set node NQ is connected to the second power line D2 with the pulldown transistor T14 interposed therebetween. The drive terminal Xn−1 is connected to the second power line D2 with the pulldown transistor T15 interposed therebetween, and the second node N2 is connected to the second power line D2 with the pulldown transistor T16 interposed therebetween.

The combined circuit FC may include the reverse node NR in a state reverse to the state of the first node N1, and the reverse node NR may be connected to the gate terminals of the pulldown transistors T11 to T16. The reverse node NR may be connected to the diode-connected first power line D1 (higher-potential power line) with the transistor T17 (power transistor) interposed therebetween and also connected to the second power line D2 (lower-potential power line) with the transistor T18 (reverse transistor) interposed therebetween, and the gate terminal of the transistor T18 may be connected to the set node NQ.

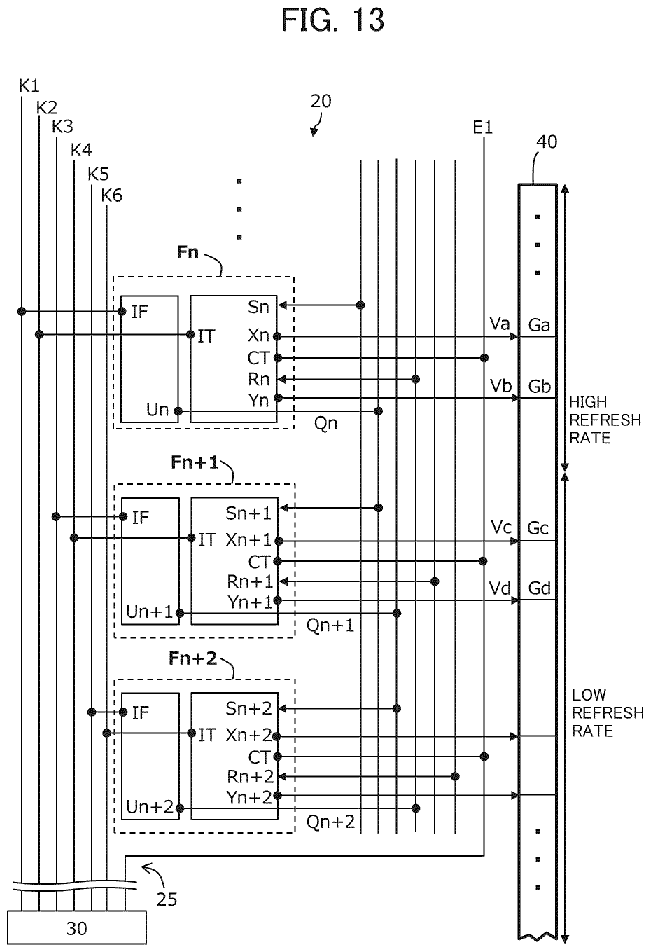

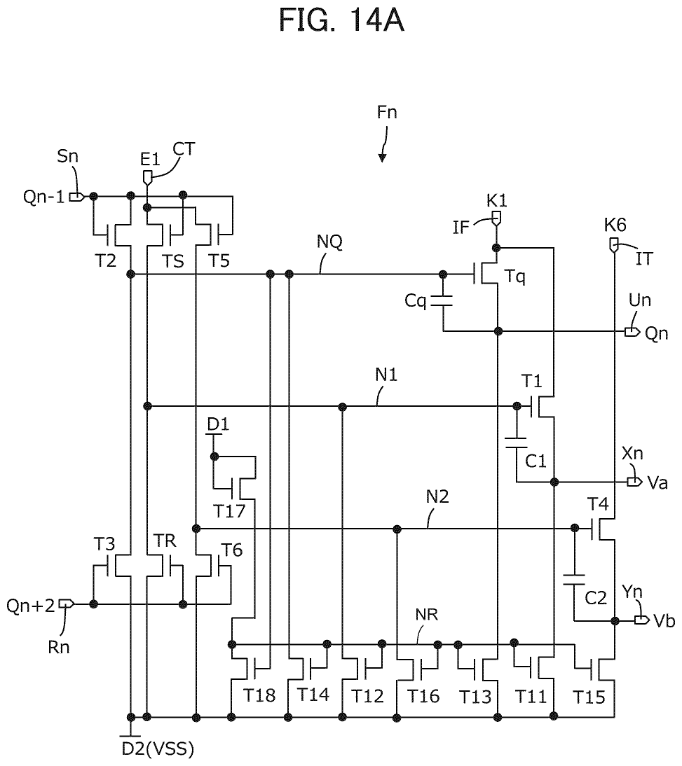

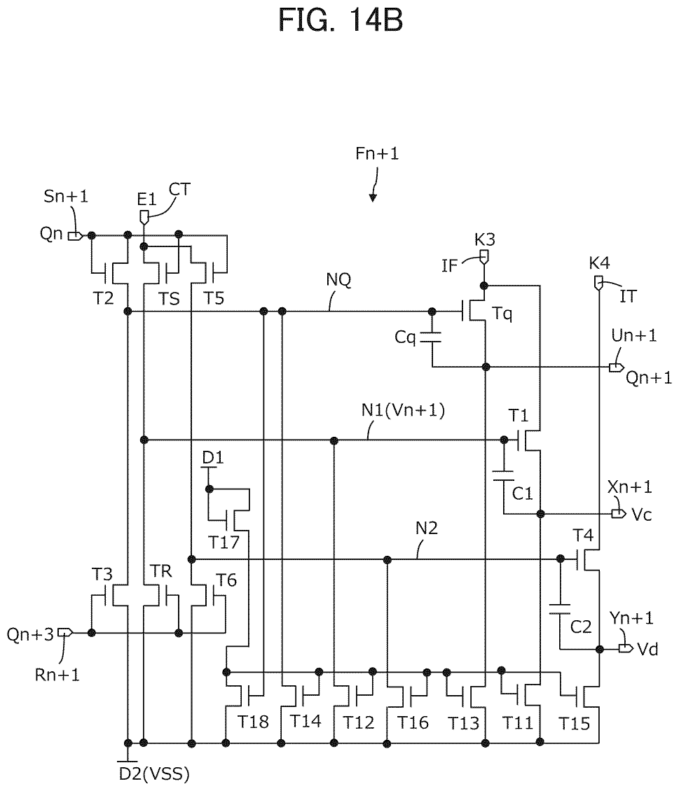

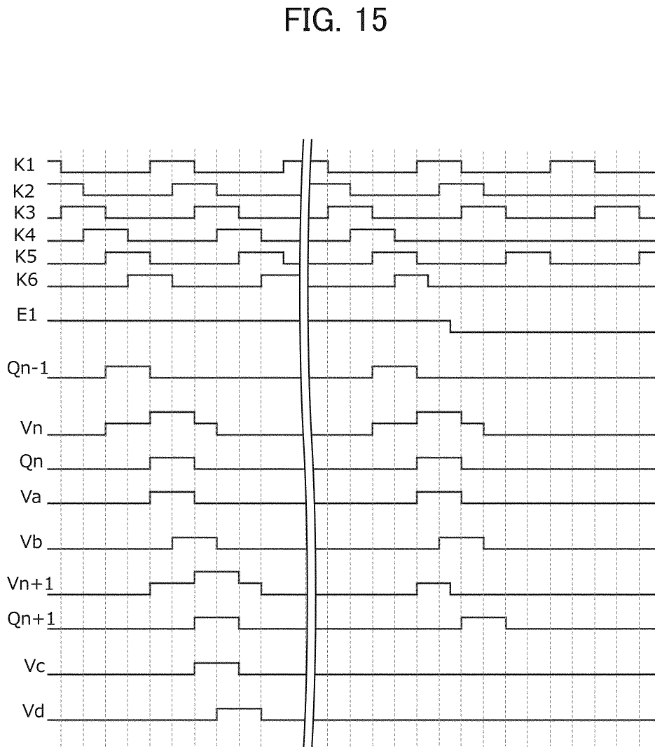

FIG. 13 is a schematic diagram illustrating a configuration of the driver circuit according to this embodiment. FIGS. 14A and 14B are each a circuit diagram illustrating an example configuration of a unit circuit. FIG. 15 is a timing chart illustrating the operations of the driver circuit according to this embodiment. The combined circuit FC illustrated in FIG. 12 may serve as a unit circuit in the nth stage to configure the driver circuit 20. As illustrated in FIGS. 13, 14A, 14B, and 15, the driver circuit 20 is a driver circuit that includes unit circuits in a plurality of stages (such as Fn, Fn−1, and Fn+1) and that drives the plurality of signal lines (such as Ga to Gc). The unit circuit En in the nth stage includes the input terminal IF that receives the clock signal K1, the drive terminal Xn that outputs the drive signal Va to one of the plurality of signal lines, the first node N1, the first transistor T1 having a gate terminal connected to the first node N1, the set transistor TS having a gate terminal that receives the set signal (for example, Qn−2) from a different stage, and the control terminal CT.

The input terminal IF is connected to the drive terminal Xn with the first transistor T1 interposed therebetween. The control terminal CT is connected to the first node N1 with the set transistor TS interposed therebetween. The control terminal CT receives the first enable signal E1 that specifies whether to enable or disable outputting the drive signal Va. Herein, n is a natural number. For example, a voltage at the first node N1 of the unit circuit Fn is Vn, and a voltage at the first node N1 of the unit circuit Fn+1 is Vn+1.

The unit circuit Fn may include the first node N1, the set node NQ, the first to third transistors T1 to T3, the set transistor Tq, and the eleventh to eighteenth transistors T11 to T18 in addition to the second capacitor C2, the fourth to sixth transistors T4 to T6, and the first capacitor C1.

In the unit circuit Fn, the input terminal IF that receives the clock signal K1 is connected to the drive terminal Xn with the first transistor T1 interposed therebetween and is also connected to the set terminal Un with the set transistor Tq interposed therebetween. The gate terminal of the first transistor T1 is connected to the first node N1, and the first node N1 is connected to the drive terminal Xn with the first capacitor C1 interposed therebetween. The input terminal IT that receives the clock signal K6 is connected to the drive terminal Yn with the fourth transistor T4 interposed therebetween. The gate terminal of the fourth transistor T4 is connected to the second node N2, and the second node N2 is connected to the drive terminal Yn with the second capacitor C2 interposed therebetween.

The control terminal CT that receives the first enable signal E1 is connected to the first node N1 with the set transistor TS interposed therebetween and is also connected to the second node N2 with the transistor T5 interposed therebetween. The gate terminals (for the set terminal Sn) of the set transistor TS and the transistor T5 receive a set signal Qn−1. The set terminal Sn is connected to the set node NQ with the transistor T2 interposed therebetween.

The gate terminals (for the reset terminal Rn) of the reset transistor TR, the transistor T3, and the transistor T6 receive a reset signal Qn+2. The first node N1 is connected to the second power line D2 with the reset transistor TR interposed therebetween, the second node N2 is connected to the second power line D2 with the transistor T6 interposed therebetween, and the set node NQ is connected to the second power line D2 with the transistor T3 interposed therebetween.

The drive terminal Xn is connected to the second power line D2 with the pulldown transistor T11 interposed therebetween, and the first node N1 is connected to the second power line D2 with the pulldown transistor T12 interposed therebetween. The set terminal Un is connected to the second power line D2 with the pulldown transistor T13 interposed therebetween, and the set node NQ is connected to the second power line D2 with the pulldown transistor T14 interposed therebetween. The drive terminal Yn is connected to the second power line D2 with the pulldown transistor T15 interposed therebetween, and the second node N2 is connected to the second power line D2 with the pulldown transistor T16 interposed therebetween.

The unit circuit Fn in the nth stage may include the reverse node NR in a state reverse to the state of the first node N1, and the reverse node NR may be connected to the gate terminals of the pulldown transistors T11 to T16. The reverse node NR may be connected to the first power line D1 (higher-potential power line) with the diode-connected transistor T17 (power transistor) interposed therebetween and also connected to the second power line D2 (lower-potential power line) with the transistor T18 (reverse transistor) interposed therebetween, and the gate terminal of the transistor T18 may be connected to the set node NQ.

As illustrated in FIG. 15, if the first enable signal E1 becomes inactive while the set signal Qn output from the unit circuit Fn is active (if the first enable signal E1 falls from High to Low in the High period of the set signal Qn), the first and fourth transistors T1 and T4 of the unit circuit Fn remain on, and pulses are output to the drive signals Va and Vb of the unit circuit Fn. However, in the unit circuit Fn+1, the first and fourth transistors T1 and T4 do not become on (remains off), and thus pulses are not output to the drive signal Vc and a drive signal Vd of the unit circuit Fn+1. The output of the drive pulse is stopped. This enables an area including the signal line (scan line) Gc and a signal line Gd in the display unit 40 to be the low refresh rate area.

Further, as illustrated in FIG. 15, the driver circuit 20 receives the clock signals K1 to K6, and, for example, the unit circuit Fn in the nth stage receives the clock signals K1 and K6 with respective different phases. However, the clock signals K1, K3, and K5 cause the shift operation in the driver circuit 20 to be kept. Accordingly, the clock signals K2 and K4 in addition to the clock signal K6 input to the unit circuit En may be kept inactive (Low) in the inactive period of the first enable signal E1 (Low period). This enables power consumption to be reduced.

The embodiment described above is provided for the purposes of illustration and description and is not intended to limit the disclosure. It is apparent to those skilled in the art that many modifications and variations may be made based on the illustration and description. The following describes the spirit of this embodiment. The term “described above” in the following description includes the content of technology disclosed with reference to at least one of FIGS. 1 to 15.

### Summarization

A driver circuit includes:
unit circuits in a plurality of stages, the driver circuit driving a plurality of signal lines,
one of the unit circuits in an nth stage including an input terminal that receives a clock signal, a drive terminal that outputs a drive signal to one of the plurality of signal lines, a first node, a first transistor having a gate terminal connected to the first node, a set transistor having a gate terminal that receives a set signal from a different stage, and a control terminal,
the input terminal being connected to the drive terminal with the first transistor interposed between the input terminal and the drive terminal,
the control terminal being connected to the first node with the set transistor interposed between the control terminal and the first node,
the control terminal receiving a first enable signal that specifies whether to enable or disable outputting the drive signal.

In the driver circuit described above,
the unit circuit in the nth stage includes a clock terminal that receives the clock signal, a set terminal that outputs a set signal to one of the unit circuits in a different stage, a set node, a set transistor having a gate terminal connected to the set node, and a second transistor having a gate terminal that receives the set signal,
the clock terminal is connected to the set terminal with the set transistor interposed between the clock terminal and the set terminal, and
the set node is connected to one of two conductive terminals of the second transistor.

In the driver circuit described above,
in the second transistor, the gate terminal is connected to a different one of the two conductive terminals.

In the driver circuit described above,
the unit circuit in the nth stage includes a first capacitor and a set capacitor,
the first node is connected to the drive terminal with the first capacitor interposed between the first node and the drive terminal, and
the set node is connected to the set terminal with the set capacitor interposed between the set node and the set terminal.

In the driver circuit described above,
the unit circuit in the nth stage includes an output circuit and a register circuit, the output circuit including the input terminal, the drive terminal, the first node, and the control terminal, the register circuit including the clock terminal, the set terminal, and the set node.

In the driver circuit described above,
the drive signal becomes active in an active period of the first enable signal.

In the driver circuit described above,
the drive signal does not become active in an inactive period of the first enable signal.

In the driver circuit described above,
in the active period of the first enable signal, activation of the first node in response to the set signal causes the first transistor to be on and the first capacitor to be charged, and rise of the clock signal causes a voltage at the first node to be increased.

In the driver circuit described above,
activation of the set node in response to the set signal causes the set transistor to be on and the set capacitor to be charged, and rise of the clock signal causes a voltage at the set node to be increased.

The driver circuit described above further includes:
a first power line and a second power line,
the unit circuit in the nth stage has a reset transistor that receives a reset signal from a succeeding stage side, and
the first node is connected to the second power line with the reset transistor interposed between the first node and the second power line.

In the driver circuit described above,
the unit circuit in the nth stage has a third transistor that receives the reset signal from the succeeding stage side, and
the set node is connected to the second power line with the third transistor interposed between the set node and the second power line.

In the driver circuit described above,
the first power line is a higher-potential power line, and the second power line is a lower-potential power line,
the unit circuit in the nth stage has a reverse node in a state reverse to a state of the first node and a plurality of pulldown transistors each having a gate terminal connected to the reverse node, and
the drive terminal and the first node are each connected to the second power line with a corresponding one of the pulldown transistors interposed between the second power line and one of the drive terminal and the first node.

In the driver circuit described above,
the unit circuit in the nth stage receives the first enable signal,
one of the unit circuits in an (n+1)th stage receives a second enable signal, and
activation timing between the first enable signal and the second enable signal differs by a predetermined time.

In the driver circuit described above,
the unit circuit in the nth stage receives the first enable signal,
one of the unit circuits in a (n+1)th stage receives a second enable signal,
deactivation timing between the first enable signal and the second enable signal defers by a predetermined time.

In the driver circuit described above,
the predetermined time is shorter than time corresponding to a pulse width of the clock signal.

In the driver circuit described above,
the predetermined time is time corresponding to a phase difference between the clock signal input to the unit circuit in the nth stage and a clock signal input to the unit circuit in the (n+1)th stage.

In the driver circuit described above,
the unit circuit in the nth stage includes the output circuit and the register circuit, and one of the unit circuits in an (n−1)th stage includes an output circuit and a register circuit, the output circuit including an input terminal, a drive terminal, a first node, and a control terminal, the register circuit including a clock terminal, a set terminal, and a set node.

In the driver circuit described above,
one of the unit circuits in an (n−1)th stage includes an output circuit including an input terminal, a drive terminal, a first node, and a control terminal and does not include a register circuit.

In the driver circuit described above,
the unit circuit in the nth stage and the unit circuit in the (n−1)th stage receive clock signals with respective different phases, and
one of the clock signals that is input to the unit circuit in the (n−1)th stage is kept inactive in an inactive period of the first enable signal.

In the driver circuit described above,
the plurality of signal lines are each a scan line, and
the drive signal is a scan signal.

In the driver circuit described above,
the plurality of signal lines are formed in a display unit in which a refresh rate is settable on a per-area basis.

In the driver circuit described above,
full scan and partial scan are performed, the full scan being performed to scan all of the plurality of signal lines, the partial scan being performed to scan part of the plurality of signal lines.

A display device includes:
the driver circuit described above.

The display device described above further includes:
a display unit in which a refresh rate is settable on a per-area basis.

The present disclosure contains subject matter related to that disclosed in Japanese Priority Patent Application JP 2024-110455 filed in the Japan Patent Office on Jul. 9, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A driver circuit comprising:
unit circuits in a plurality of stages, the driver circuit driving a plurality of signal lines,
one of the unit circuits in an nth stage including an input terminal that receives a clock signal, a drive terminal that outputs a drive signal to one of the plurality of signal lines, a first node, a first transistor having a gate terminal connected to the first node, a set transistor having a gate terminal that receives a set signal from a different stage, and a control terminal,
the input terminal being connected to the drive terminal with the first transistor interposed between the input terminal and the drive terminal,
the control terminal being connected to the first node with the set transistor interposed between the control terminal and the first node,
the control terminal receiving a first enable signal that specifies whether to enable or disable outputting the drive signal.

2. The driver circuit according to claim 1,
wherein the unit circuit in the nth stage includes a clock terminal that receives the clock signal, a set terminal that outputs a set signal to one of the unit circuits in a different stage, a set node, a set transistor having a gate terminal connected to the set node, and a second transistor having a gate terminal that receives the set signal,
wherein the clock terminal is connected to the set terminal with the set transistor interposed between the clock terminal and the set terminal, and
wherein the set node is connected to one of two conductive terminals of the second transistor.

3. The driver circuit according to claim 2,
wherein in the second transistor, the gate terminal is connected to a different one of the two conductive terminals.

4. The driver circuit according to claim 2,
wherein the unit circuit in the nth stage includes a first capacitor and a set capacitor,
wherein the first node is connected to the drive terminal with the first capacitor interposed between the first node and the drive terminal, and
wherein the set node is connected to the set terminal with the set capacitor interposed between the set node and the set terminal.

5. The driver circuit according to claim 2,
wherein the unit circuit in the nth stage includes an output circuit and a register circuit, the output circuit including the input terminal, the drive terminal, the first node, and the control terminal, the register circuit including the clock terminal, the set terminal, and the set node.

6. The driver circuit according to claim 1,
wherein the drive signal becomes active in an active period of the first enable signal.

7. The driver circuit according to claim 6,
wherein the drive signal does not become active in an inactive period of the first enable signal.

8. The driver circuit according to claim 4,
wherein in the active period of the first enable signal, activation of the first node in response to the set signal causes the first transistor to be on and the first capacitor to be charged, and rise of the clock signal causes a voltage at the first node to be increased.

9. The driver circuit according to claim 4,
wherein activation of the set node in response to the set signal causes the set transistor to be on and the set capacitor to be charged, and rise of the clock signal causes a voltage at the set node to be increased.

10. The driver circuit according to claim 2, further comprising:
a first power line and a second power line,
wherein the unit circuit in the nth stage has a reset transistor that receives a reset signal from a succeeding stage side, and
wherein the first node is connected to the second power line with the reset transistor interposed between the first node and the second power line.

11. The driver circuit according to claim 10,
wherein the unit circuit in the nth stage has a third transistor that receives the reset signal from the succeeding stage side, and
wherein the set node is connected to the second power line with the third transistor interposed between the set node and the second power line.

12. The driver circuit according to claim 10,
wherein the first power line is a higher-potential power line, and the second power line is a lower-potential power line,
wherein the unit circuit in the nth stage has a reverse node in a state reverse to a state of the first node and a plurality of pulldown transistors each having a gate terminal connected to the reverse node, and
wherein the drive terminal and the first node are each connected to the second power line with a corresponding one of the pulldown transistors interposed between the second power line and one of the drive terminal and the first node.

13. The driver circuit according to claim 1,
wherein the unit circuit in the nth stage receives the first enable signal,
wherein one of the unit circuits in an (n+1)th stage receives a second enable signal, and
wherein activation timing between the first enable signal and the second enable signal differs by a predetermined time.

14. The driver circuit according to claim 1,
wherein the unit circuit in the nth stage receives the first enable signal,
wherein one of the unit circuits in a (n+1)th stage receives a second enable signal,
wherein deactivation timing between the first enable signal and the second enable signal defers by a predetermined time.

15. The driver circuit according to claim 13,
wherein the predetermined time is shorter than time corresponding to a pulse width of the clock signal.

16. The driver circuit according to claim 13,
wherein the predetermined time is time corresponding to a phase difference between the clock signal input to the unit circuit in the nth stage and a clock signal input to the unit circuit in the (n+1)th stage.

17. The driver circuit according to claim 5,
wherein the unit circuit in the nth stage includes the output circuit and the register circuit, and one of the unit circuits in an (n−1)th stage includes an output circuit and a register circuit, the output circuit including an input terminal, a drive terminal, a first node, and a control terminal, the register circuit including a clock terminal, a set terminal, and a set node.

18. The driver circuit according to claim 5,
wherein one of the unit circuits in an (n−1)th stage includes an output circuit including an input terminal, a drive terminal, a first node, and a control terminal and does not include a register circuit.

19. The driver circuit according to claim 18,
wherein the unit circuit in the nth stage and the unit circuit in the (n−1)th stage receive clock signals with respective different phases, and
wherein one of the clock signals that is input to the unit circuit in the (n−1)th stage is kept inactive in an inactive period of the first enable signal.

20. A display device comprising:
the driver circuit according to claim 1; and
a display unit in which a refresh rate is settable on a per-area basis,
wherein the plurality of signal lines are each a scan line, and the drive signal is a scan signal, and
wherein the plurality of signal lines are formed in the display unit.
